(19) United States
(12) Patent Application Publication
(10) Pub. No.: US 2012/0271884 A1
(43) Pub. Date: Oct. 25, 2012

(54) User Preference Surveys

(75) Inventors: Russell Eric Holmes, Auckland (NZ); Glenn Linley Robson, Auckland (NZ)

(73) Assignee: Luvitorshuvit Limited, Auckland (NZ)

(21) Appl. No.: 13/498,860

(22) PCT Filed: Sep. 28, 2010
(86) PCT No.: PCT/NZ2010/000190

§ 371 Date: Jun. 6, 2012

(30) Foreign Application Priority Data
Sep. 29, 2009 (NZ) 580050

(51) Int. Cl. G06F 15/16

(52) U.S. Cl. 709/204

(57) ABSTRACT

A method and system for providing recommendations or targeted content to a user of a user apparatus comprising: presenting a user preference survey 130 with one or more options for election on the user apparatus 11a-11c, for each survey, receiving and storing the result of the survey to create or update a user profile 130, identifying other users 150 that match the user based on respective user profiles 130, and providing targeted content and/or recommendations of targeted content to the user apparatus 11a-11c, being content preferred by one or more of the matching users 150.

### FIELD OF THE INVENTION

The present invention relates to a system and method for building user profiles using user preference surveys, whereby a user profile can be used to match users and deliver targeted content to the user, such as marketing and media content.

### BACKGROUND TO THE INVENTION

Computer and other network enabled devices can be used as a means to deliver content to users. However, often that content is delivered in an ad hoc way, with little thought given to whether the content is suitable or not for the end user.

### SUMMARY OF THE INVENTION

It is an object of the present invention to provide apparatus and/or method for building a user profile for use in delivering targeted content to users.

In one aspect the present invention may be said to consist in a method of providing recommendations or targeted content to a user of a user apparatus comprising: presenting a user preference survey with one or more options for election on the user apparatus, for each survey, receiving and storing the result of the survey to create or update a user profile, identifying other users that match the user based on respective user profiles, and providing targeted content and/or recommendations of targeted content to the user apparatus, being content preferred by one or more of the matching users.

Preferably identifying others users that match the user based on user profiles comprises identifying other users with the same or similar preferences to the user for a content category.

Preferably the method further comprises associating one or more of the matching users with the user, and wherein the targeted content is content preferred by one or more of the associated matching users.

Preferably providing targeted content or recommendations of targeted content comprises indicating to the user or providing the user with access to content preferred by one or more of the matching users or associated matching users.

Preferably associating one or more of the matching users comprises presenting the matching users on the user apparatus and receiving input from the user apparatus selecting one or more of the matching users for association.

Preferably the user preference survey is a primary survey that comprises two options for election, of which one can be elected in preference to the other, the primary survey having the predominant purpose of obtaining elections to create or update the user profile.

Preferably one or more of the options relate to content being preferred by one or more matching or associated matching users, the survey providing recommendations and/or targeted content, and/or also obtaining elections to create or update the user profile.

Preferably the user preference survey is a secondary survey that comprises two or more options for election, wherein one or more of the options relate to content being preferred by one or more matching or associated matching users, the secondary survey providing recommendations and/or targeted content, and/or also obtaining elections to create or update the user profile.

Preferably the method further comprises presenting a survey provided to one or more other users and receiving a prediction of how the other users responded to that survey.

Preferably the result of the survey comprises an election of one or more of the options and/or feedback on the survey.

Preferably the election is an indication of preferring or not preferring the option, or providing a rating.

In another aspect the present invention may be said to consist in a system for providing recommendations or targeted content to a user of a user apparatus comprising: a database to store one or more user profiles, and a computer programmed to: provide a user preference survey to a user apparatus with one or more options for election on the user apparatus, for each survey, receive and store the result of the survey to create or update a user profile in the database, identify other users that match the user based on respective user profiles, provide targeted content and/or recommendations of targeted content to the user apparatus, being content preferred by one or more of the matching users.

Preferably the computer is further programmed to identify other users that match the user based on user profiles by identifying other users with the same or similar preferences to the user for a content category.

Preferably the computer is further programmed to associate one or more of the matching users with the user.

Preferably to associate one or more of the matching user with the user, the computer is programmed to provide the matching users to the user apparatus, and receive input from the user apparatus selecting one or more of the matching users for association.

Preferably providing targeted content and/or recommendations to targeted content comprises providing access to content preferred by one or more of the matching or associated matching users.

Preferably the user preference survey is a primary survey that comprises two options for election, of which one can be elected in preference to the other, the primary survey having the predominant purpose of obtaining elections to create or update the user profile.

Preferably the user preference survey wherein one or more of the options relate to content being preferred by one or more matching or associated matching users, the survey providing recommendations and/or targeted content, and/or also obtaining elections to create or update the user profile.

Preferably the user preference survey is a secondary survey that comprises two or more options for election, wherein one or more of the options relate to content being preferred by one or more matching users or associated matching users, the secondary survey providing recommendations and/or targeted content, and/or also obtaining elections to create or update the user profile.

Preferably the computer is further programmed to present a survey provided to one or more other users and receiving a prediction of how the other users responded to that survey.

Preferably the result of the survey comprises an election of one or more of the options and/or feedback on the survey.

Preferably the election is an indication of preferring or not preferring the option, or providing a rating.

In another aspect the present invention may be said to consist in a method of building a user profile for use in providing recommendations and/or targeted content to a user of a user apparatus comprising: creating or selecting at least one user preference survey, the survey comprising one or more options for election, presenting the preference survey on the user apparatus, and for each survey, storing the result of the survey to create or update a user profile, wherein each user preference survey is selected/created based on one or more of: the user profile, surveys presented to and/or created by other matching users with the same or similar profile and/or responses thereto and/or preferences thereof, the prediction accuracy of the user and/or other users, and/or uptake history of previous surveys and/or content, and providing recommendations and/or targeted content to the user apparatus based on the user profile and/or the user profiles of other matching users.

In another aspect the present invention may be said to consist in a system for building a user profile for use in providing recommendations and/or targeted content to a user of a user apparatus, the system comprising: a database to store one or more user profiles, and a computer programmed to: create or select at least one user preference survey, the survey comprising one or more options for election, provide the preference survey to a user apparatus, for each survey, create or update a user profile in the database, and provide recommendations and/or targeted content to the user apparatus based on the user profile and/or the user profiles of other matching users, wherein each user preference survey is selected/created by the computer based on one or more of: the user profile, surveys presented to and/or created by other matching users with the same or similar profile and/or responses thereto and/or preferences thereof, the prediction accuracy of the user and/or other users, and/or uptake history of previous surveys and/or content.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

The term “comprising” as used in this specification means “consisting at least in part of”. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF LIST OF FIGURES

Preferred embodiments of the invention will be described with reference to the following drawings, of which:

FIG. 1 shows a system for building a user profile and delivering targeted content based on user profiles,

FIG. 2 shows a screen on a user apparatus displaying a user preference survey in a first embodiment,

FIG. 3 shows an example of a profile stored on a profile database in the second embodiment,

FIG. 4 shows a flow diagram for building a user profile for the first embodiment,

FIGS. 5-11 show screenshots of user functionality of the system for the first embodiment,

FIG. 12 shows a block diagram of creation of advertising content for the first embodiment,

FIG. 13 shows a flow diagram for a second embodiment,

FIG. 14 shows a screen on a user apparatus displaying a primary user preference survey for the second embodiment,

FIG. 15 shows an example of a profile for a user in the second embodiment,

FIG. 16 shows an example of a user profile of a potential matched user in the second embodiment,

FIG. 17 shows an example of screen showing a primary user preference survey and matched users in the second embodiment,

FIG. 18 shows and example of a secondary user preference survey in the second embodiment.

### DETAILED DESCRIPTION OF PREFERRED EMBODIMENTS

The present invention relates to an apparatus, system and method for building user profiles for delivering targeted content (such as advertising, or information on goods and services for sale) to a user based on their profile. The term “content” can relate to the subject matter of the delivered content itself and/or the media format in which the subject matter is delivered. The term ‘survey” can mean one or a combination of surveys.

### Overview of Invention

The present invention provides a way to build and utilise user profiles that indicate user preferences. In general terms, one or more surveys are generated and/or selected and presented to the user. The user's response to a survey is obtained and then a user profile is created/updated based on the response to the survey. Further surveys and/or content can be generated and/or selected based on the user profile and presented to the user. Further, other users with similar preferences can be identified and suggested to the user. The preferences of those users can be utilised to present further surveys and/or content to the user.

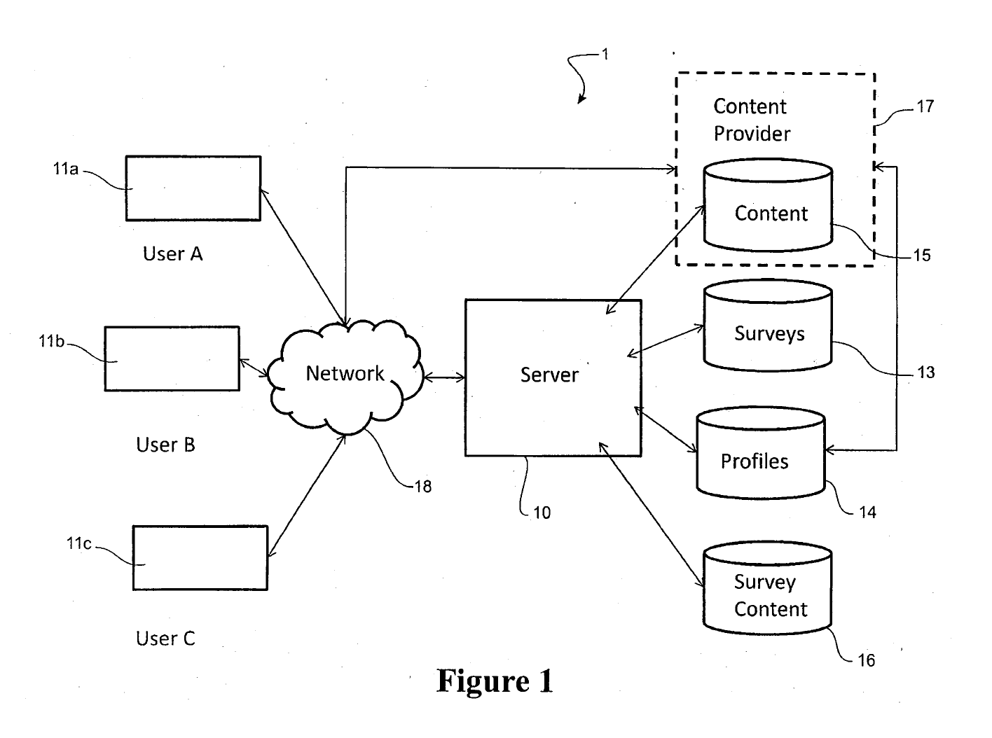

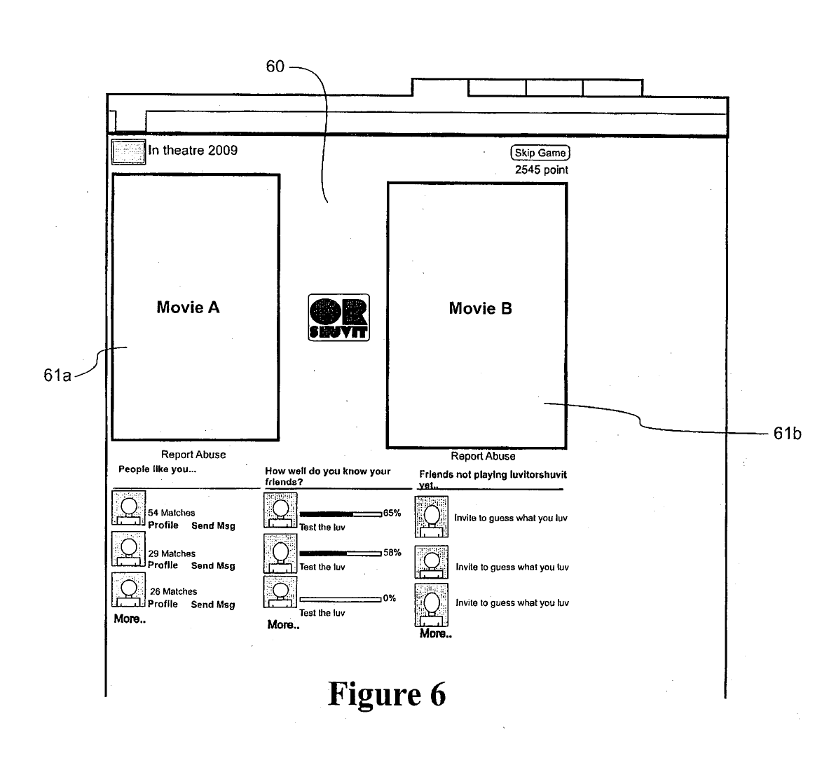

FIG. 1 is a block diagram showing generally a system 1 that can build a user profile for a number of users and optionally deliver targeted content based on the user profiles. The system operates a method in conjunction with user apparatus to build user profiles. The profiles are then utilised by the system operator and/or third party content providers to provide targeted content. The targeted content might comprise, for example, adverts, promotions, services, goods, entertainment, information or the like delivered via any suitable media format, such as images, video, audio, URL or combination thereof. The targeted content might also comprise further surveys, each of which might comprise targeted content such as that set out above. Referring to FIG. 1, the system 1 comprises a server 10 that can select and/or generate user preference surveys (“surveys”) (see, for example, FIG. 6), selectively provide those surveys to users and receive user responses to the surveys. These responses are used to build profiles of the users. To achieve this, the server 10 communicates with a number of user apparatus 11a-11c via a network 18, such as the internet, landline network, cellular network or similar. Each user apparatus 11a-11c can be any device or machine that is capable of: communicating with the server 10 via the network 18, receiving content from the server 10 for displaying on a browser or other application of the user apparatus, executing a survey for interactive feedback from a user, and sending user input back to the server. Typically, the user apparatus 11a-11c could be an internet capable computer with a client browser, or alternatively a portable communications device such as a display enabled PDA, mobile telephone, games console or the like running a client application.

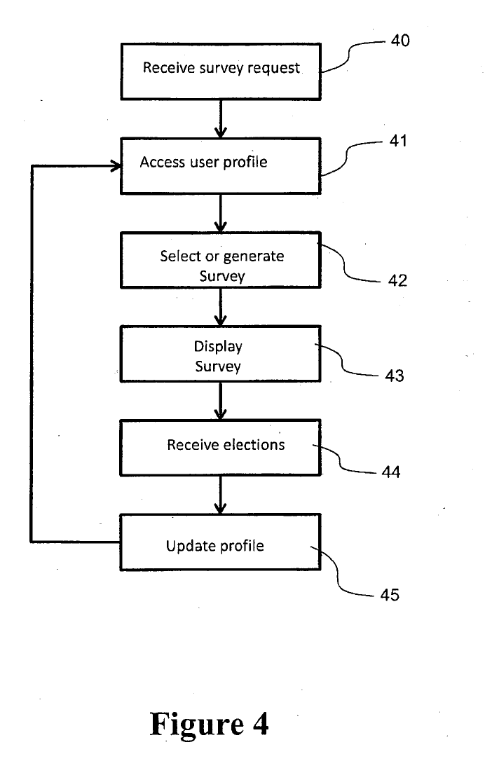

The server 10 is connected to a profile database 14 that contains records defining user profiles 30 (e.g. as shown in FIG. 4). The server 10 can access information on user profiles from the profile database 14 and update the profile database 14 with new user profile information. The server updates the profile database 14 for a user based on the user responses to surveys. The server 10 can create and/or select surveys for delivery to the user apparatus 11a-11c. The surveys are created and/or selected based on the user profile 30 information. For example, it can select pre-generated surveys stored in a survey database 13. These can be surveys generated by the server 10 itself, third party providers and/or users of the system 1. Alternatively, the server 10 can generate new surveys itself using content obtained relevant sources, e.g. survey content database 16. The survey could be at least partially generated and/or selected based on the responses or preferences of other users of the system, and most preferably other matched users that have been identified as having similar preferences to the users. The server 10 periodically or upon demand selects/generates and delivers surveys to particular users 11a-11c and, based on their respective profiles 30 (e.g. as shown in FIG. 4), uses the responses to update the current user profile 30 in the profile database 14. Using the user profile 30 to generate/select a survey increases the probability that the survey is relevant to the user(s) it is being delivered to. This increases the probability of receiving a response, and makes any responses more relevant to updating user profile 30, making that profile a more accurate reflection of the user's preferences. The server 10 can provide surveys to each user periodically or upon demand. Over time, based on the elections made by the user in response to displayed surveys, the profile is updated and provides useful information on the preferences of the user.

The server 10 can then deliver targeted content 15 to users, selected/generated based on user profiles 30. The content can come from a third party providers e.g. 17, or alternatively can come from/be generated by the server system 1 itself. The targeted content provides a customised “channel” for the particular user to which it is delivered. The targeted content can also double as a further survey.

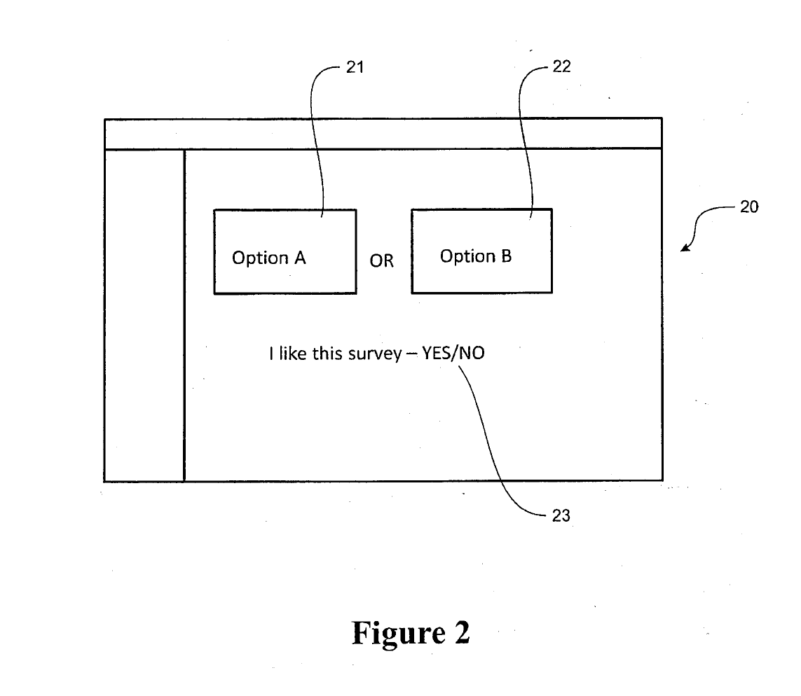

FIG. 2 shows in general how a user preference survey might operate. The user apparatus display 20 (which might be a browser or similar) renders one or more options 21, 22 for election, the options forming the survey delivered by the server 10, Only two options are shown here, but there could be many more, or simply one option. Each option will relate to some type of item that might be of interest to the user. Each option could, for example, relate to a good, service, movie, artist, game or the like or any genre or category. The content could be more general than this. The user can then elect one or more of the options 21, 22 in the survey. This election can relate to their like, dislike, rating or otherwise of those one or more options 21, 22. The survey can also might also contain an option 23 to elect, rate or otherwise indicate the like or dislike of the survey itself. Each survey could have a theme, topic, genre or category, or similar (such as entertainment, movies, food or activities).

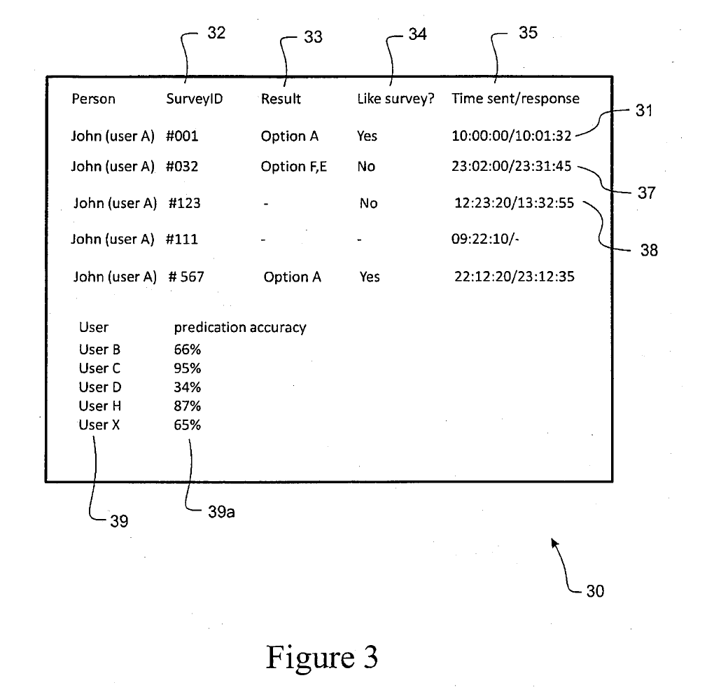

FIG. 3 shows an example of a stored profile 30 for a user (User A—John). It will be appreciated that this Figure displays the nature the information stored, and not necessary the structure of the database in which it is stored. Each time a response is made to a survey by a user, a record e.g. 31 is created in profile 30. The record comprises a Survey ID 32, which contains information that embodies the content of the survey, or points to a database that stores a record of the survey. For example, the survey might provide the choice between vanilla and chocolate ice-cream. Next, the result 33 of the survey is stored. This comprises a record of all the elections made by the user for that survey. For example, it might contain a record that the user elected vanilla ice-cream for the survey. Zero or multiple elections can be recorded, depending on the user's response as shown in records 37, 38. The user's feedback on the survey itself (whether they liked or disliked it) is also stored 34. Each survey delivered can have a time stamp 35. This can be recorded, along with the time when the user responded to the survey. This information can be utilised to determine early adopters of trends, popular culture, etc. Earlier adopters are those who make elections on surveys time that is well before others generally do. For example, earlier adopters may like a particular movie, artist or product long before other users make a similar election. These earlier adopters are likely to better know trends or are more likely to be influential in deciding what becomes the next “big thing”.

The above is not an exhaustive list of what can be stored in the user profile. Any useful information for indicating a user's preferences can be stored. A large number of records relating to a large number of surveys can be created for each user. It should be noted that FIG. 4 shows a small number of records of a profile for just one user. The actual profile database 13 will comprise profiles for all users. Also, the profile contains prediction information 39 on other users, which will be described later.

### First Embodiment

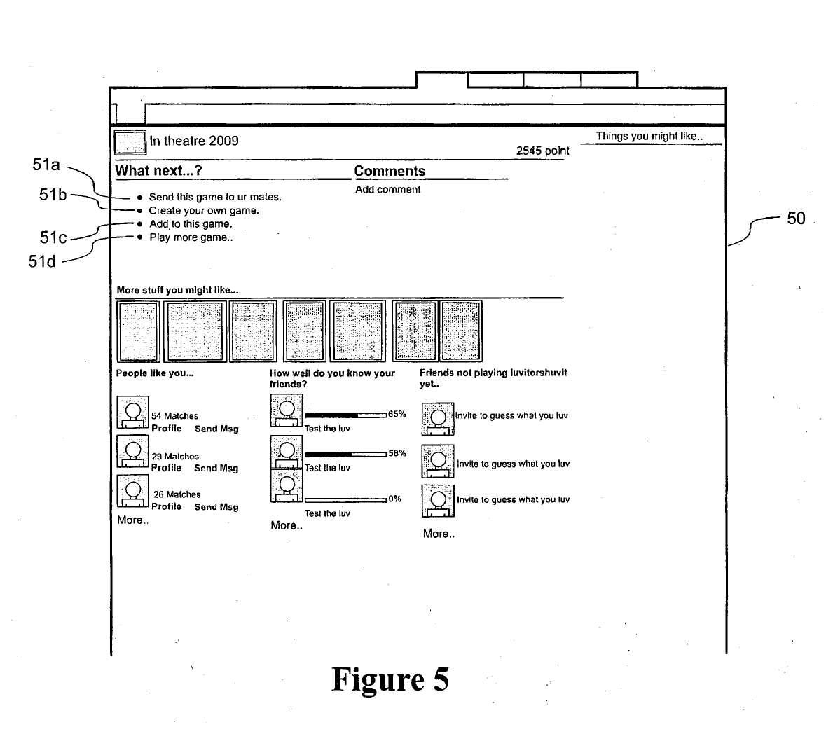

One possible embodiment of the invention will be described with reference to FIGS. 1, and 4 to 7. This embodiment is provided as part of the functionality of a social networking website, in which a survey can be provided to a user's (in this case user A) internet enabled computer 11a and displayed on the browser. First, the user (e.g. user A) accesses social networking website 50 as shown in FIG. 5. This provides a home page where the user can participate in a survey (“game”) 51d, create a survey 51b, and/or send the survey to a friend 51a. In this case, the user wants to participate in a survey 51d. The website server 10 receives this election, step 40 and then accesses the user profile data database 14, step 41. Next, the server selects or creates a survey for user A, step 42, which contains one or more options for election by the user. The survey is generated/selected from a database 16/13 to contain options that are likely to be of interest to the user based on their user profile 30. The survey could be at least partially generated and/or selected based on the responses or preferences of other users of the system, and most preferably other users that have been identified as having similar preferences to the users. In this case, the survey 60 comprises two movie options—movie A 61a and movie B 61b as shown in FIG. 6.

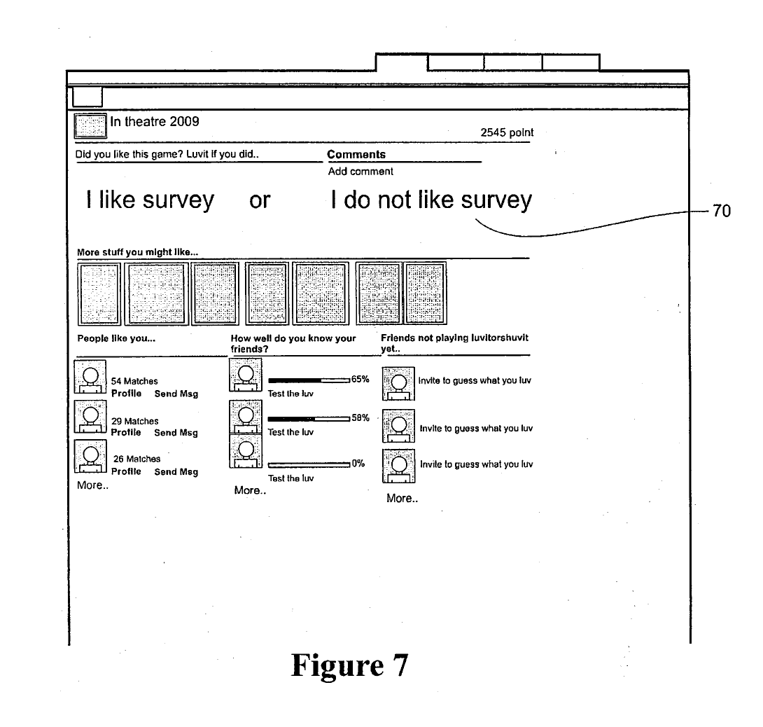

Once selected/created, the survey is delivered to the user computer 11a via the internet and displayed on their browser, step 43. The user then elects which option they prefer (or can elect both or neither option), step 44. As an alternative, the user can give a rating (e.g. percentage) to either or both options. Referring to FIG. 7, user may also get to elect their preference overall (either like, dislike and/or rating) on the survey itself 70. This indicates whether they thought it was a good or relevant survey that they liked or not. The elections from the survey options and survey itself is provided back to the server 10 and used to update the user profile 30 in the database 14 as discussed above, step 45. If the survey is of no interest whatsoever to the user, they can choose not to respond at all, or to “skip” that particular survey.

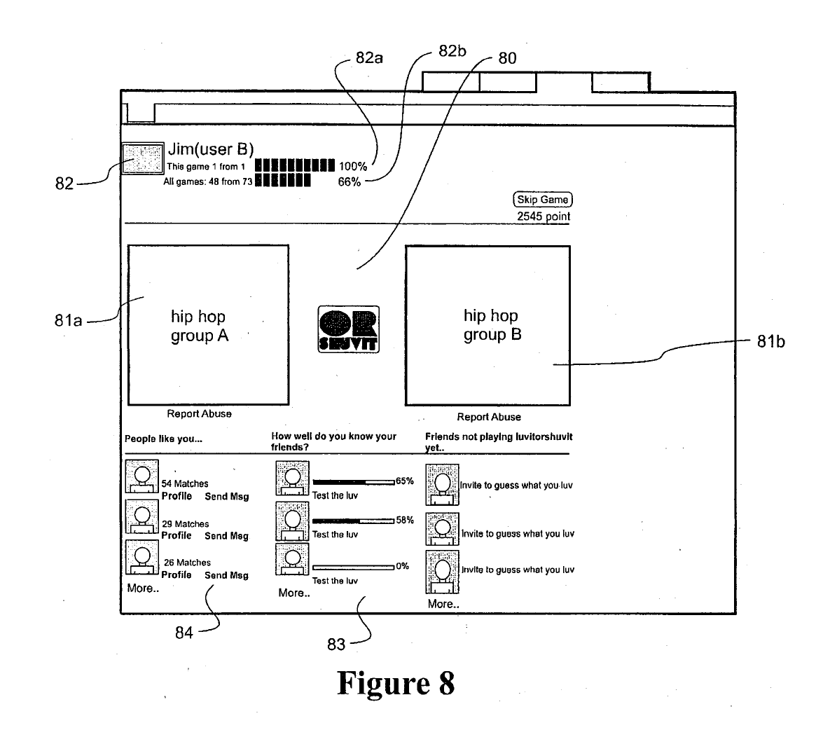

Referring to FIG. 8, the server 10 can in addition deliver a survey 80 that has already been delivered to other users. In addition to requesting the user's election on that survey 80, additional functionality is provided whereby the user can indicate how they believed other users responded to the same survey 80. Here, the survey presented to user A asks if they like hip hop group A 81a or hip hop group B 81b, and allows them to make an election. The survey has also been provided to another user B (Jim) 82. User A can also predict or guess which hip hop group Jim elected. In this case it was hip hop group B. An icon 82a shows whether the response is correct. The icon also shows 82b for that user, how often user A correctly predicts Jim's elections (in this case 66%).

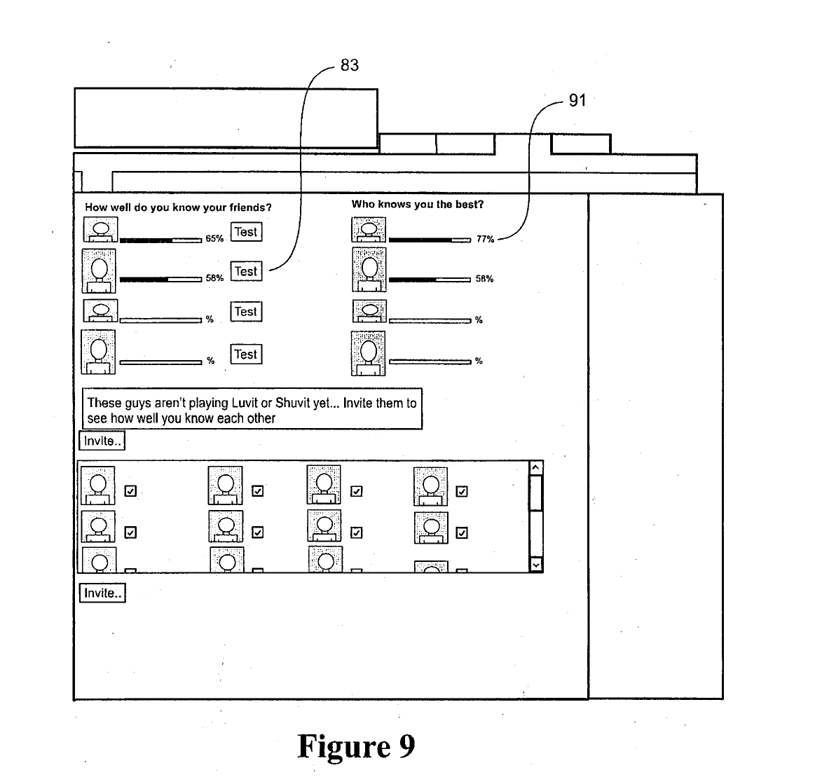

Returning to FIG. 3, the server 10 receives this prediction input from user A and keeps a record 39 of how correctly they can predict or know the elections made by user B in the user A's profile 30. User A's predictions can be made for a number of users (e.g. user C, D, H, X as shown in FIG. 3). The number of correct predictions user A makes for each other user is stored 39. A score 39a (such as a percentage) of how user A has predicted the elections of particular other users is displayed. Referring to FIGS. 8 and 9, the website page will also display this information. It shows a) how well user A knows people in their social network (by showing user A's prediction accuracy 83 as shown in FIG. 8, b) those people who know user A best (being those who can predict user A's elections, to a certain degree of accuracy 91 as shown in FIG. 9), and c) people who are like user A (being associated or matching users with the same or similar profile to user A 84 as shown in FIG. 8).

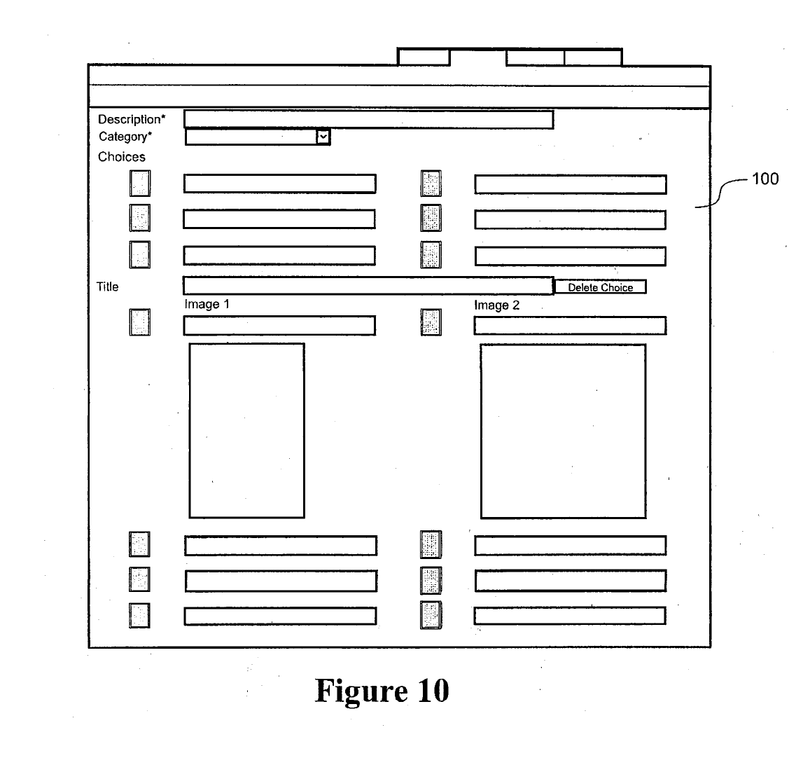

Referring to FIG. 10, each user has the ability to create their own surveys for delivering via the server 10 to users in their own social network or other users. This option 51b can be selected on the home page 50 in FIG. 5. FIG. 10 shows one possible manner in which a survey could be generated. Relevant information is entered into text boxes (see generally 100) such as genre or category of the survey, the description, the options for election and also media content for uploading to form part of the survey. A range of options might be provided for selection by the creator of a survey, or else they could enter their own fresh information. Once created, the survey can be sent to other users by selecting the option 51a on the home page 50 shown in FIG. 5. It also forms part of the survey database 13, and can be selected by the server 10 for sending to other users where it deems appropriate based on the creator's and receivers' respective user profiles.

The manner in which a user profile is updated and how this is used to select or generate the surveys for providing to the user will now be described in detail with reference to FIGS. 3 and 4.

When a user (e.g. user A) elects to participate in a survey, or one is automatically provided by the server, the server must generate/select a survey that is suitable. It does this by accessing the user profile, step 41, from the profile database 14 as shown in FIGS. 3 and 4. Once the server 10 has this information, it selects/generates a survey using one of a number of techniques.

In one option, the server will simply randomly generate/select a survey and provide this with no reference to the profile information. This is the least desirable option and will usually only be done in the early stages of a user subscription when the user profile is not well developed. In another option, a survey is selected or generated that contains options related to elections made previously. For example, if certain hip hop groups have been elected by the user in past surveys, the server might select a survey related to hip hop, or might generate one from options relating to the hip hop groups previously selected. Many alternatives are possible.

In another option, the server will select a previously generated survey that has already been presented to another associated/matching user (e.g. user B) that has a similar or the same profile to user A. Finding a similar user for this purpose comprises searching other user profiles and finding one in which the other user has participated in the same or similar surveys and has provided the same or similar responses. Exact correspondence is not required for a match, so for example correspondence might be occur when a threshold level of identical surveys are completed by both users with a threshold level of similar elections. For example, where users have participated in a certain number or percentage of identical surveys with a certain number or percentage of similar responses, they may be considered associated/matching users. Alternatively, it might be based on whether both users liked the same surveys when they made the election of those survey themselves, although this is not essential.

In another option, the server 10 will select or generate a survey based on whether or not the user is an “early adopter” of new trends, products and entertainment, for example. Those who make elections quickly, or make elections before others do might be selected as suitable recipients of surveys relating to new products, services, trends etc. and other as they are more likely to adopt them and propagate this information to others. They become desirable users as they provide a way to gain quick traction in the market place. An early adopter could include someone who elects a relatively unknown option in a survey (such as an obscure film) that initially is ignored or unnoticed by people, but later becomes extremely popular once popular culture catches on.

In another option, the server 10 will select a survey (created by another user) for user A, when the creator selects user A as a suitable recipient of that survey. Also, the server can use these surveys and select them for providing to a particular user based on the profile of the creator and/or the profile of the user to which it will be provided. For example, where users have similar profiles, the survey created by one user might be sent to the other user as it is likely the survey will be of interest to them. In addition, where the creator of a survey (e.g. user B) is good at predicting the elections of a particular user (e.g. user A), then the survey created by user B could be selected and sent to user A on the basis user B knows the preferences of user A, and so user B's survey will be relevant. If user B elects user A to receive the survey, and user B knows user A well, then the server is more likely to select that survey for deliver to user A because of user B's understanding of user A's preferences. The survey is more likely to be relevant to user A.

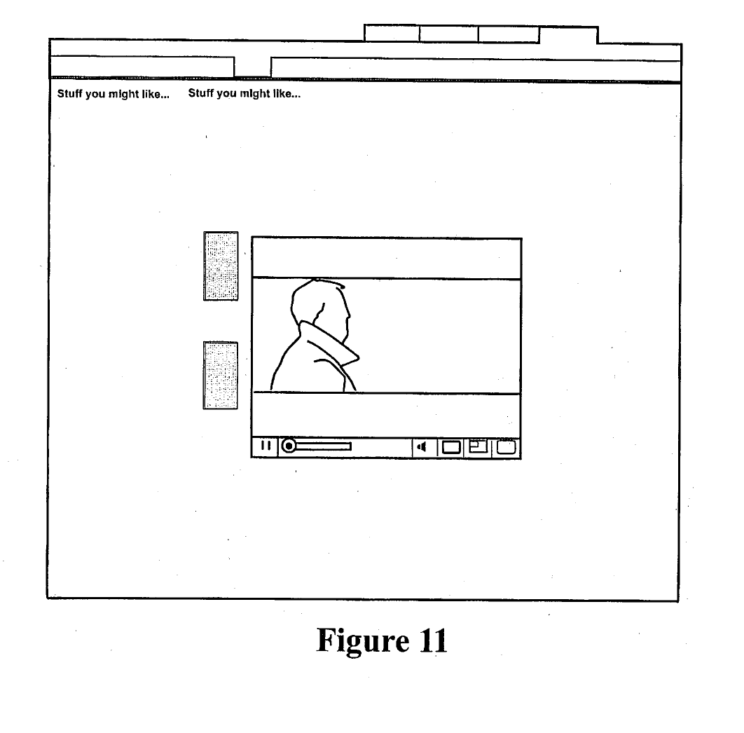

The profile of a user can be utilised by the server operator or third parties to provide content of interest to that user. This media content can be targeted, measurable, and customised so that it is relevant to the particular user that it is being sent to. The content can take any useful form as described earlier. FIG. 11 shows an example of content, in this case a movie trailer for a particular movie about to be released. The trailer will be selected for deliver to a user based on their user profile. The trailer might be selected based on an actual option election in a survey, or simply based on a related genre that matches the user's profile generally. The entity running the profile building system 1 can receive remuneration from those third parties using that profile information through advertising revenue and/or subscriptions or similar.

Content can be customisable for a particular user. For example, an advertisement for a product might have different versions, each with different backing tracks, graphics, presenters and the like. When deliver the advertisement for the product to the user, the version of advertisement that is more likely to appeal to them can be selected based on their profile.

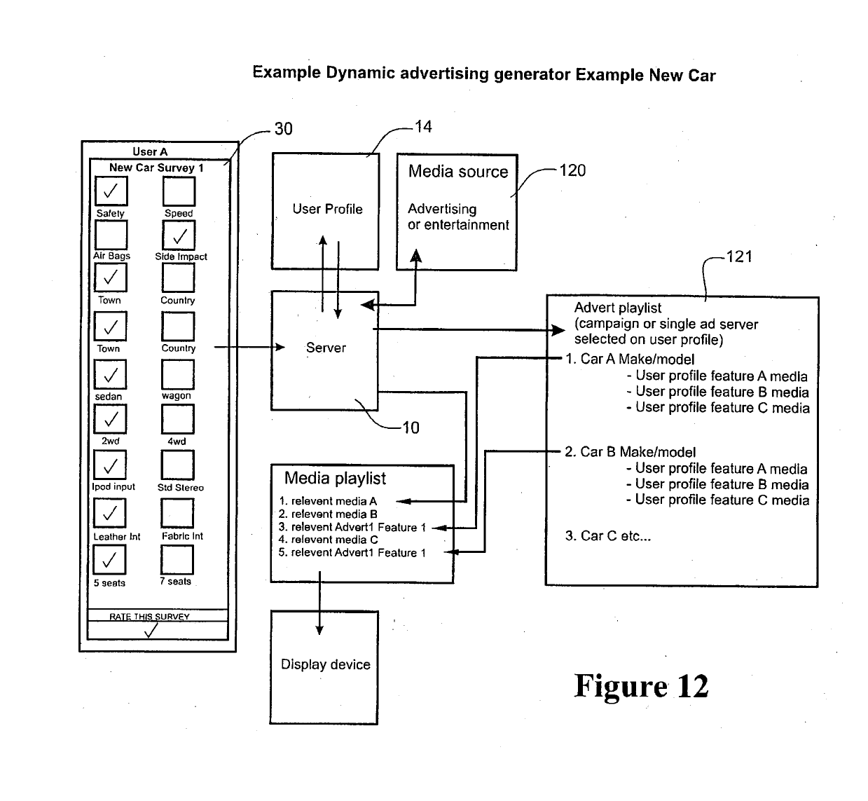

An example of this is shown in FIG. 12. The server 10 is to deliver a car advertisement to a user. It first obtains the user's profile 30, which contains information (obtained from previous surveys) about the user's important preferences for cars, including safety, intended use, interior features, size and the like. A car manufacturer might have a range of possible advertisements for a range of cars, each containing content focussing on different car features. The advertisement can be customised for a user based on this. The base advertisement is obtained from a source and passed the server 10. The server 10 then accesses an advertisement playlist 121 which pulls in various content for the advertisement. The server 10 then prepares a playlist from the various content for delivering to a user.

It will be appreciated therefore that the invention comprises a) user profiling building through use of surveys, wherein the surveys are selected/generated based on user profiles; and b) providing actual content, which is selected or generated and delivered to particular users based on user profiles.

The embodiment described above would operate on a web server that serves web pages for a social networking site for display on internet capable computers. However, is not essential that the invention is provided in this manner. The functionality could be provided independently of a social networking site, or even alternatively part of a different type of communications network advice for communications between user apparatus. Peer to peer systems could work instead of client server model, for example.

### Second Embodiment

Another embodiment will now be described with reference to FIGS. 1, and 13 to 18.

### Overview of Second Embodiment

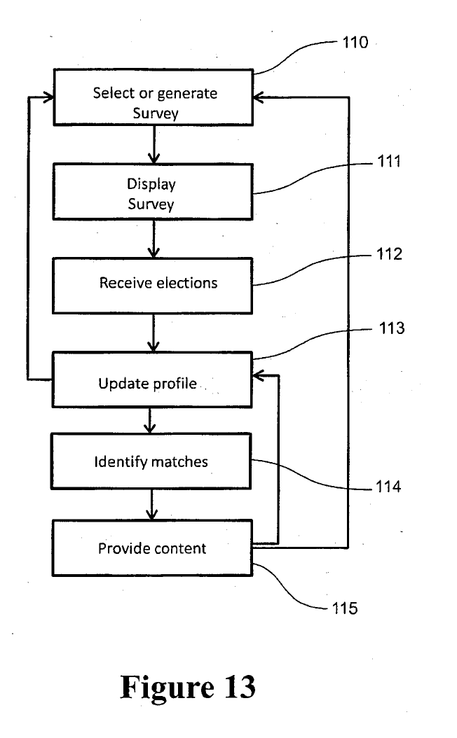

As shown in FIG. 13, in this embodiment, a survey can be selected or generated, step 110, and then presented to the user, step 111. The survey preferably, although not necessarily, comprises multiple surveys arranged as a game. The game can belong to a category, e.g. art, music, film or the like. The user then responds to the survey, step 112, by electing a desired option and/or by indicating whether they like the survey. The response is used to update the user profile, step 113. More surveys can then be generated and presented, steps 110-113.

In addition, based on the response to the survey and/or the consolidated user profile, other users with similar preferences in the same or across categories can be identified and indicated to the user, these becoming matching users, step 114. The user may opt to associate themselves (for example, by subscribing to them) with one or more of the matching other users, one or more categories. Alternatively, the system might automatically associate (by, for example, subscription) the user with one or more of the matching users. In the general case, the matching users (and associated matching users) for a particular user will differ across categories. It should be noted that through their participation, the user themselves might become a matching user or associated matching user for other users.

The user can then be provided with access to or be delivered content that is preferred by the matching users or associated matching users, step 115. The user effectively “follows” the matching or associated matching users by being provided with access to their preferred content. Preferred content (also termed “preferences”) is content that the matching users have previously indicated they like, for example through preference surveys they have participated in and/or content they themselves have chosen to review through other means. In addition, further preference surveys can then be selected and/or generated and presented to the user, step 110-115. The further surveys can be selected and/or generated based on the user profile and/or preferences of the matching users or associated matching users. For example, further preference surveys might contain content preferred by matching users or associated matching users, and this survey can be a mechanism by which to provide preferred content, step 115, 110.

### Further Detail of Second Embodiment

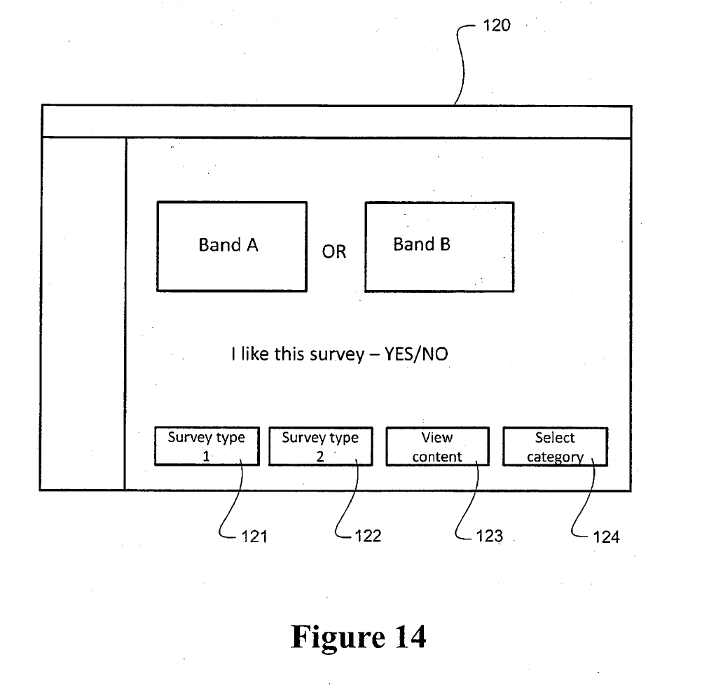

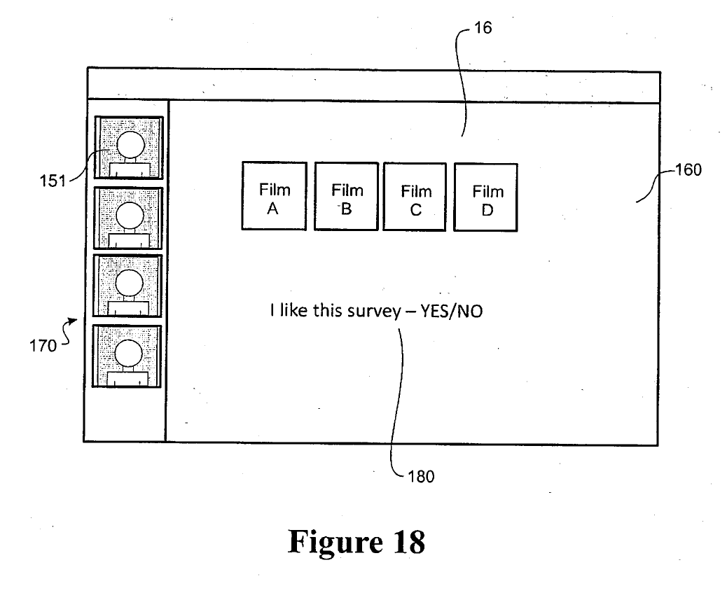

The second embodiment will now be described in more detail with reference to FIGS. 1, and 13 to 18. Referring to FIG. 13, first the preference survey is selected or generated, step 110, by the server 10 in a suitable manner, as described in relation to FIG. 4. There are two types of surveys that can be generated or selected in this embodiment—a primary survey e.g. 120 (see FIG. 14) or a secondary survey e.g. 160 (see FIG. 18). Preferably, the primary survey 120 comprises a number of surveys, whereby the user has the option to select between one of two options for each survey. The predominant purpose of this survey is to obtain elections of preferences, step 112, from the user from which to update their user profile, step 113. The secondary survey 160 comprises a number of options relating to content, whereby the user has the option to select one (or possibly more) of the options that indicate their preferences, step 112, and/or also review that content. The content relating to the options provided in the survey can be selected based on the preferences of the user's matching users or associated matching users. The purpose of this secondary survey is to provide content or access to content for the user, e.g. at step 115, but also to receive feedback on their preferences of that content, step 112, in order to update their user profile and/or identify content that might be of interest and can be delivered to matching users, step 115.

In one option, the system could determine which type of survey is delivered to the user. For example, it might depend on various events whereby one or more primary surveys e.g. 120 are initially provided to the user, and after a profile is built and matching users are found, then the system switches to providing second surveys e.g. 160, predominantly for providing content to the user. Alternatively, the user might select which of the survey types are delivered, depending on whether they predominantly want to review content, or alternatively whether they predominantly want to make choices to update their profile.

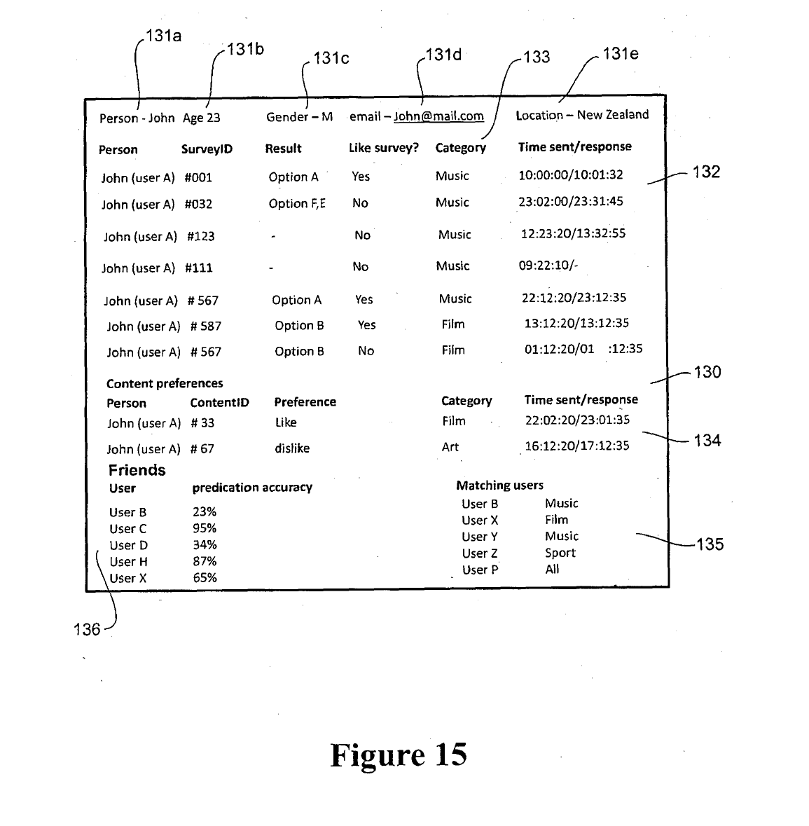

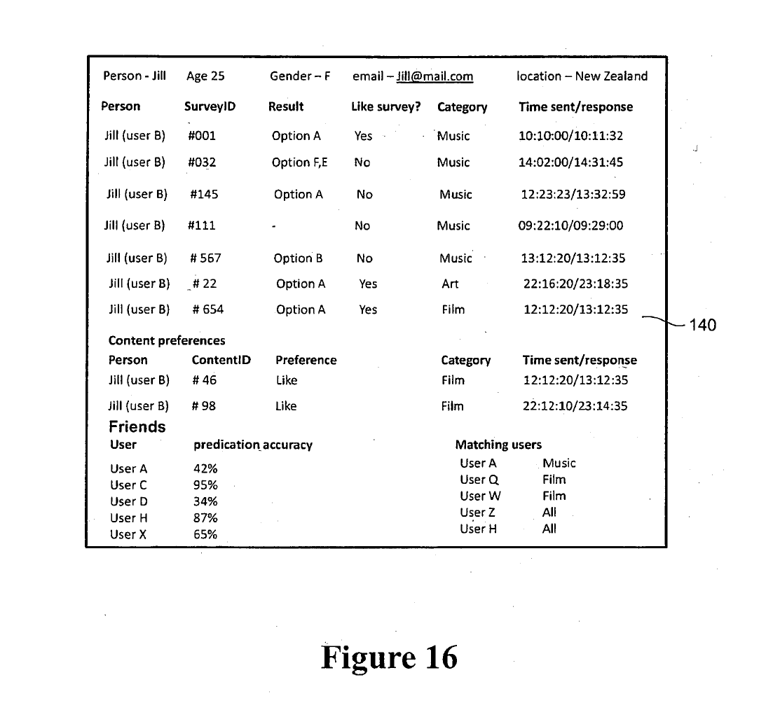

Once generated or selected, the survey of either type is provided over a network 18 to a user and displayed to them, step 111. The user (e.g. User A) then inputs elections indicating their preferences (preferred option or options) on the user apparatus e.g. 11a (see FIG. 1). This input is received over the network 18 by the server 10, step 112. The server 10 updates the user profile, e.g. 130 (see FIG. 15), step 113. It then finds matching users to the user A, step 114, by comparing the user's profile 130 with the profiles e.g. 140 (see FIG. 16) of one or more other users (e.g. user B, 11b), step 114. As part of this step, the server 10 indicates these matching users (e.g. user B) to the user via the user A apparatus e.g. 11a. The server 10 also preferably associates one or more of these matching users with the user, or alternatively could be arranged to receive input from the user apparatus e.g. 11a, indicating which matching users the user wants to be associated with, step 114. Content that has been selected and preferred by matching users or associated matching users can be presented by the server 10 to the user via the user apparatus e.g. 11a, either directly (independently from a survey) or via secondary surveys, step 115. Such content that is reviewed and preferred or liked by the user can in turn be presented to other users for which the user is a matching or associated matching user, step 116. All such activity can be utilised to update the user profile 130.

### Exemplary Implementation of Second Embodiment

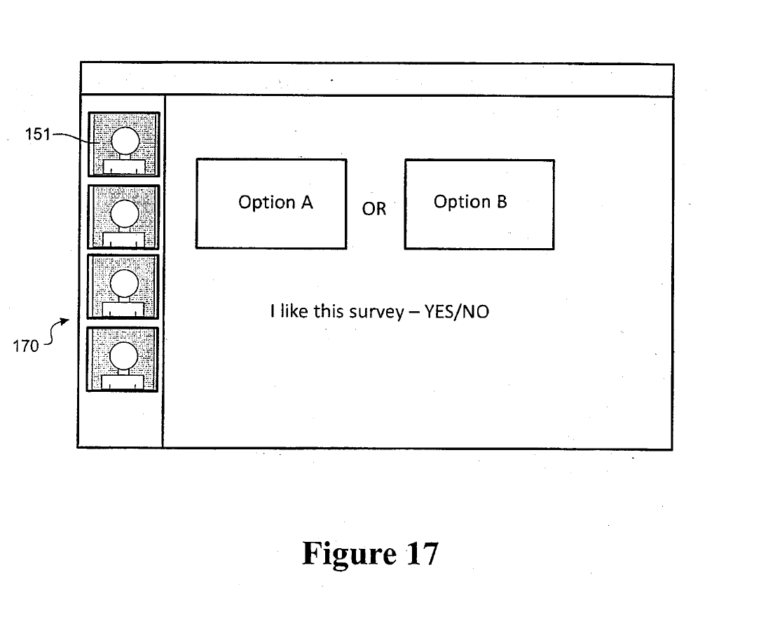

An exemplary implementation of the second embodiment is described with reference to FIGS. 1 and 13 to 18. Referring to FIG. 12, the implementation is provided to the user e.g. user A, via the user apparatus 11a as a browser based application, optionally as part of a social networking website. The user can select, but clicking the respective icon 121, 122, 123, between:
a) receiving primary surveys 120, to general indicate their preferences and update their profile (icon 121),
b) receiving secondary surveys 160, which provide targeted content or recommendations of such content base on the preferences of matching users or associated matching users (icon 122), or
c) receiving target content or recommendations of targeted content from matching users or associated matching users independently from a survey (icon 123 or by selecting a subscribed user—see FIG. 17).

The user can also select a category of content (icon 124), such as music, films, art, sport or the like.

### Implementation of the Second Embodiment with a Primary Survey

If the user elects to receive primary surveys 120, a game (forming a primary survey) comprising multiple dual choice surveys is generated and delivered, steps 110, 111. The options in the survey 120 relate to the selected category. Referring to FIG. 14, an example of one (primary) survey in such a game is shown. Here, the category is music, so the user is offered a choice of their preferred musical band, Band A or Band B, step 112. Preferably each choice is indicated by media content, such as a static image. Each band choice is also associated or linked to other content or surveys that are related to that choice. The associations and the other content are stored in a database, such as database 13, 15 and 16 of FIG. 1. For example Band A and B might each be linked to other songs or videos by the same band or, artists, or to songs or videos of bands in the same genre. The linked content could take the form of, or be provided as one or more URLs to: a website, a search engine, a media channel, repository or a website to purchase the content. Each option might also be linked to other surveys with related content. In response to the survey 120, the user elects their preferred option and rates the survey (e.g. like/dislike or a percentage rating) or by the system putting a rating when the user reaches a threshold of positive responses), step 112. They can select their preferred option, for example, by hovering over the image of that option and selecting it with a mouse to show their like for that option. Alternatively, they could have the ability to show their dislike for that option. As the user responds to each survey in the game, the server 10 receives these responses, step 112, and updates the profile 130 in the profile database 14 (or creates it, if the user is participating for the first time), step 113.

FIG. 15 shows the user profile, which provides a simplified example of a typical profile, which is similar in nature to that described for FIG. 4. It can comprise any or all of the previous types of fields described previously. It also comprises the name 131a, age 131b, gender, 131c, email 131d and location 131e of the user. Like described previously, it also comprises a record of preferences generated from the responses to primary surveys that the user has participated in e.g. 132, for each category 133. If for example the user selected Band A, shown in the survey of FIG. 14, then the entry 12 would be created, as part of updating the user profile, step 113. A time stamp can also be recorded, for the purposes of identifying early adopters, as described previously. In addition, the profile keeps a record of content that the user has reviewed and indicated that they like (prefer) or dislike e.g. 134. This could be content they have viewed or provided via any mode, including preferred content viewed automatically, upon selecting a recommendation from a matching user, or via a secondary survey. This content and the preferences can then in turn be used to create surveys, or to provide or recommended the content other users that follow the user as an associated or matching user. Another section 135 is provided, which indicates users that have been identified as matching or associated matching users (subscribed users). These are the users that are followed—the content they prefer is provided or recommended to the user via surveys or other means. The user profile 130 might also comprise a list of “friends” 136, with which the user has associated themselves with via other facilities, such as a social networking website.

After the user profile is updated, step 113, the same selection process then occurs for subsequent surveys, until all surveys in the game have been responded to by the user. Also, at that point, the server 10 then identifies other users 11a-11c that have the same or similar preferences to the user, based on the respective user profiles of the user 130 and the other users e.g. user B, 140, to identify the matching users. For example, the server 10 selects another user (e.g. user B, 11b) that is a candidate for matching and compares the user profile e.g. 140 of that candidate user with the user profile 130 of the current user (user A, 11a), to determine the degree of similarity between their preferences. FIG. 16 shows the simplified user profile 140 for user B, which has the same structure, but different content, to the user profile 130 of user A. One way to conduct the comparison between users is to analyse the respective responses to identical surveys they have both participated in, and determine the number of responses that are the same. For example, referring to FIGS. 15 and 16, both users (John and Jill) have participated in surveys #001, #032, #111 and #567. They had the same answers on surveys #001, #032 and #111. If some threshold measure is reached (e.g. they have more than 70% of responses that are the same) then they are identified as a match. In this case, users John and Jill would be a match.

Other factors to consider in the matching users are the similarities in respective locations, ages, gender, and associated friends. The preferences of friends and their ability to predict current user preferences (prediction accuracy) could also be used to match users and make them matching or associated matching users. Another consideration is the respective users' responses to their overall like or dislike of particular surveys. The timestamp of an election of preference in a survey along with the subsequent preference of another user for the same item might also be used to match users and elevate the early adopter statues of the first user. There might also be degrees of matching, were users who have more preferences/factors in common are a higher match than those who have some but fewer preferences/factors in common. Staged thresholds could be set up to determine this, and the degree of matching indicated by a number, level or some other indicia.

Further, in determining matches based on survey results, this is preferably done on a category basis. That is, when comparing a candidate user with a user to determine a match, the preferences from surveys relating to a specific category will be considered independently. So when the candidate user is compared, the system will first look at matches for the movie category, then the arts category, the music category and so on. An independent decision is made for each category whether the candidate user matches the user in that category based on their respective responses to the same surveys in that category. It is possible, and likely, that a particular candidate might be a match for some categories and not others. Therefore, the matching users or associated matching users for a particular user, might only be that for one or some of the categories. For example, referring to FIGS. 15 and 16, these two might match for music, as they have at least 75% of survey responses in common for that category, but they might not match for movies, where they have no survey responses in common. In this case, when preferred content from an associated matching user is provided to the user, it will only be provided for content falling in categories for which they have been matched. It will be appreciated however, that while category matching can be done, matching users can also be identified based on survey results across all categories. In this case, even if a matching user does not have sufficient similarity in their survey responses to the user in a particular category, over all categories they might have sufficient similarity to be deemed a match. In this case, when preferred content of the associated matching user is provided to the user, it could be content from any category.

Once one or more matching candidate users are identified in this manner, they are earmarked as matching users, step 114. In this implementation, each matching user is automatically associated with the user. If the user does not want to follow that matching user, they will proactively unsubscribe. However, other implementations might operate differently. For example, in another implementation, only some users will be associated automatically and/or the user might proactively select associate themselves (select/subscribe) with one or more of the matching users. Further, in one possible implementation, no association is made, and matching users are simply identified to the user. The associated users 170 are shown on the display screen, such as in FIG. 17. Once associated matching users are established, content preferred by those users can be provided to the user, either as a survey, or directly and independent from a survey, as will be described below.

The user can then play another survey game, update the profile and find matching other users, as set out above steps 110-115. Subsequent primary surveys 120 are generated in the following manner. The system 1 generates a group of candidate surveys comprising or generated from a) surveys that have not yet been presented to the user, b) surveys and/or content associated with the elected option of the first survey and/or c) surveys suggested by or previously presented to other users the user subscribes to/is matched to. The candidate surveys are then ranked according to the users own preferences and/or how those candidate surveys have been previously rated by other users (such as matched/associated users. For example, a rating for a particular survey might comprise the proportion of other users who previously indicated they liked the survey or be rated by the system in terms of an exceeded threshold of positive responses to the survey. The highest ranked survey is the selected as the subsequent survey and presented to the user. Their response is then obtained and their profile updated, and more matching users are found.

### Delivering Targeted Content in the Second Embodiment

The preferred content of matching or associated matching users becomes targeted content for the user that is following the matching users. Any indication of that content, e.g. via images or the like, is a recommendation of that target content. Once matching users are found, their preferred content can be delivered or otherwise provided to the user in several ways, as mentioned above, step 115.

In the first option, as mentioned above and referring to FIG. 18, the content can be provided as a secondary survey 160, generated and displayed as part of the method shown in FIG. 11. In this case, the content is displayed as part of steps 110 and 111, rather than step 115. In this type of survey a number of choices are provided 160, from which the user can select one (or possibly more) options, step 112. Preferably, each option indicates preferred content, e.g. a video, music or the like, that has been selected based on the preferences of associated matching users the user has subscribed to. Each media item in turn may represent a media item or link (URL)). Each item of content is represented by an image or similar in the survey, allowing the user to identify the content and decide which they prefer. When a selection is made, step 112, the content is presented to the user (e.g. the video is played) by the server 10, via the user apparatus e.g. 11a. The user also has the option of indicating that they like or dislike the content, which is stored in section 134 of the user profile 130. For example, in FIG. 18, the user can select between various films. They select film A and view it, then indicate they like it resulting in entry 134 of the user profile 130. If they like the content, it then becomes preferred content for the user, which can be provided to other users who follow the user (as a matching user). Likewise, the user themselves can also receive content and/or surveys from the suggested users they have subscribed to. This will be content that the other users have viewed or, for example, selected in a survey.

In the second option, referring to FIG. 17, the server 10 sends information indicating the associated matching users to the user apparatus, so they can be displayed and identified to the user 170. The category they match for can also be indicated. Examples of some or all of the preferred content (or links to that content indicated by, e.g., images) for each associated matching user can be displayed e.g. 151. The user can select the link and review the content, for example by viewing and/or listening to it, step 115. They can also indicate whether they like the content or not 180, which will be updated on their profile 130, for providing preferred content to those that follow them.

In the third option, alternatively, the user can select a portion of the website whereby the targeted content is automatically delivered to the user, so they can review it, e.g. icon 123 in FIG. 17, step 115. The order of delivery can be determined by the system in any suitable way, such as by deferring to the degree of matching between the users. The user can elect to stop reviewing the content, and choose to review other preferred content if they desire, thus overriding the automatically delivery. Doing so can cause the server to update the user profile 130, giving an indication that they do not like the content. If they select particular content, then the user profile 130 can be updated by the server to indicate that they like (prefer) that content. In addition, a user could be asked whether they like or dislike the content, and their response is received by the server, which updates the user profile 130 accordingly. This again identifies preferred content that can be provided to those that follow them.

It will be appreciated that various other alternatives to the invention are possible. The particular method for matching users, generating/selecting surveys and providing preferred/targeted content, and the manners in which surveys and content are displayed are not limited to those examples described above. Other alternatives comprise the following.

Content might not be provided directly, but as links or represented with static images, logos, words or the like. A user can then click on that link or representation to review the content.

Presentation of each choice consists of an optional title to the choice, a required media item (for example, but not limited to, static image, video, audio), a required text description that doubles as a keyword search term and optional additional keywords for each option.

Surveys may also contain recommendation information. This information represents the recommendation of an entity based on a user's selection of preference for that item. The entity may represent another survey (e.g. recommendation of ‘Hip Hop albums’ survey may exist on preference of Hip Hop Band A over Rock Band B).

Survey recommendations may be system generated based upon keywords of choices (e.g. recommendation of Hip Hop Band A songs survey may be generated by matching the survey title with the choice description in the Hip Hop Band A versus Rock Band B choice). Survey recommendations may be made by matched users, or through auction bid. Or a combination of matched users preferences and auction bid. Bids placed by advertisers for slots in surveys ranked by a combination of bid price and results of previous surveys for the current user, or by users matched to the current user, may alter rankings, ordering, and introduction of new items into surveys for the current user.

Media items may be uploaded by the user, or selected from sources through keyword search. The system retrieves relevant media and presents them to the user for selection.

Results from a survey may be used by the system to build additional surveys (e.g. winner of A v B paired with winner of C v D creates a new choice A v C)

Keywords from survey results may be used to generate single item list surveys (secondary surveys). For example, user preference for soccer may be used by the system to generate a single item survey of soccer videos)

Keywords from survey results of users matched to the current user can be used to generate new surveys, and introduce new items into surveys for the current user.

The source can comprise multiple versions of particular content, wherein a version can be selected for delivery to a user based on their user profile.

Preferably the source comprises surveys created by other users and/or a computer system.

Preferably the election is an indication of preferring or not preferring the option, or providing a rating.

A method of providing content to a user apparatus comprising: selecting/creating content from a source based on a user profile, presenting that content to the user apparatus, wherein the user profile is created according to one or more of the paragraphs above.

A user apparatus for building a user profile for use delivering targeted content to a user apparatus, the apparatus having a display and being connected or connectable to a computer system and programmed to: receive, create or select at least one user preference survey, the survey comprising one or more options for election, present the preference survey on the display, and for each survey, store or transmit for storage the result of the survey to create or update a user profile, wherein each survey is selected/created based on one or more of: the user profile, user preference surveys presented to and/or created by other users with the same or similar profile, the prediction accuracy of the user and/or other users, and/or uptake history of previous user surveys.

A system for building a user profile for use in selecting media content for delivery to a user apparatus, the system comprising:

a computer programmed to: create or select at least one user preference survey, the survey comprising one or more options for election, provide the preference survey to a user apparatus, and for each survey, store the result of the survey to create or update a user profile,
wherein each survey is selected/created based on one or more of: the user profile, user preference surveys presented to and/or created by other users with the same or similar profile, the prediction accuracy of the user and/or other users, and/or uptake history of previous user surveys.

A system for providing content to a user apparatus comprising: a server for selecting/creating content from a source based on a user profile, the server adapted to deliver that content to the user apparatus, wherein the user profile is created according to one or more of the paragraphs above.

A system for providing content to a user apparatus comprising: a server for selecting/creating content from a source based on a user profile, the server adapted to deliver that content to the user apparatus, wherein the user profile is created according to one or more of the paragraphs above.

A user apparatus for displaying content to a user comprising: a network connection for receiving content from a server that is selected/created from a source based on a user profile, wherein the user profile is created according to one or more of the paragraphs above, and a display for displaying the content.

1. A method of providing recommendations or targeted content to a user of a user apparatus comprising:
presenting a user preference survey with one or more options for election on the user apparatus,
for each survey, receiving and storing the result of the survey to create or update a user profile,
identifying other users that match the user based on respective user profiles, and
providing targeted content and/or recommendations of targeted content to the user apparatus, being content preferred by one or more of the matching users.

2. A method according to claim 1 wherein identifying other users that match the user based on user profiles comprises identifying other users with the same or similar preferences to the user for a content category.

3. A method according to claim 1 further comprising associating one or more of the matching users with the user, and wherein the targeted content is content preferred by one or more of the associated matching users.

4. A method according to claim 1 wherein providing targeted content or recommendations of targeted content comprises indicating to the user or providing the user with access to content preferred by one or more of the matching users or associated matching users.

5. A method according to claim 4 wherein associating one or more of the matching users comprises presenting the matching users on the user apparatus and receiving input from the user apparatus selecting one or more of the matching users for association.

6. A method according to claim 1 wherein the user preference survey is a primary survey that comprises two options for election, of which one can be elected in preference to the other, the primary survey having the predominant purpose of obtaining elections to create or update the user profile.

7. A method according to claim 1 wherein one or more of the options relate to content being preferred by one or more matching or associated matching users, the survey providing recommendations and/or targeted content, and/or also obtaining elections to create or update the user profile.

8. A method according to claim 1 wherein the user preference survey is a secondary survey that comprises two or more options for election, wherein one or more of the options relate to content being preferred by one or more matching or associated matching users, the secondary survey providing recommendations and/or targeted content, and/or also obtaining elections to create or update the user profile.

9. A method according to claim 1 further comprising presenting a survey provided to one or more other users and receiving a prediction of how the other users responded to that survey.

10. A method according to claim 1 wherein the result of the survey comprises an election of one or more of the options and/or feedback on the survey.

11. A method according to claim 1 wherein the election is an indication of preferring or not preferring the option, or providing a rating.

12. A system for providing recommendations or targeted content to a user of a user apparatus comprising:
a database to store one or more user profiles, and
a computer programmed to:
provide a user preference survey to a user apparatus with one or more options for election on the user apparatus,
for each survey, receive and store the result of the survey to create or update a user profile in the database,
identify other users that match the user based on respective user profiles,
provide targeted content and/or recommendations of targeted content to the user apparatus, being content preferred by one or more of the matching users.

13. A system according to claim 12 wherein the computer is further programmed to identify other users that match the user based on user profiles by identifying other users with the same or similar preferences to the user for a content category.

14. A system according to claim 12 wherein the computer is further programmed to associate one or more of the matching users with the user.

15. A system according to claim 14 wherein to associate one or more of the matching user with the user, the computer is programmed to provide the matching users to the user apparatus, and receive input from the user apparatus selecting one or more of the matching users for association.

16. A system according to claim 12 wherein providing targeted content and/or recommendations to targeted content comprises providing access to content preferred by one or more of the matching or associated matching users.

17. A system according to claim 12 wherein the user preference survey is a primary survey that comprises two options for election, of which one can be elected in preference to the other, the primary survey having the predominant purpose of obtaining elections to create or update the user profile.

18. A system according to claim 17 wherein the user preference survey wherein one or more of the options relate to content being preferred by one or more matching or associated matching users, the survey providing recommendations and/or targeted content, and/or also obtaining elections to create or update the user profile.

19. A system according to claim 18 wherein the user preference survey is a secondary survey that comprises two or more options for election, wherein one or more of the options relate to content being preferred by one or more matching users or associated matching users, the secondary survey providing recommendations and/or targeted content, and/or also obtaining elections to create or update the user profile.

20. A system according to claim 12 wherein the computer is further programmed to present a survey provided to one or more other users and receiving a prediction of how the other users responded to that survey.

21. A system according to claim 12 wherein the result of the survey comprises an election of one or more of the options and/or feedback on the survey.

22. A system according to claim 12 wherein the election is an indication of preferring or not preferring the option, or providing a rating.

23. A method of building a user profile for use in providing recommendations and/or targeted content to a user of a user apparatus comprising:
creating or selecting at least one user preference survey, the survey comprising one or more options for election,
presenting the preference survey on the user apparatus, and for each survey, storing the result of the survey to create or update a user profile,
wherein each user preference survey is selected/created based on one or more of: the user profile, surveys presented to and/or created by other matching users with the same or similar profile and/or responses thereto and/or preferences thereof, the prediction accuracy of the user and/or other users, and/or uptake history of previous surveys and/or content, and
providing recommendations and/or targeted content to the user apparatus based on the user profile and/or the user profiles of other matching users.

24. A system for building a user profile for use in providing recommendations and/or targeted content to a user of a user apparatus, the system comprising:
a database to store one or more user profiles, and
a computer programmed to:
create or select at least one user preference survey, the survey comprising one or more options for election,
provide the preference survey to a user apparatus,
for each survey, create or update a user profile in the database, and
provide recommendations and/or targeted content to the user apparatus based on the user profile and/or the user profiles of other matching users,
wherein each user preference survey is selected/created by the computer based on one or more of: the user profile, surveys presented to and/or created by other matching users with the same or similar profile and/or responses thereto and/or preferences thereof, the prediction accuracy of the user and/or other users, and/or uptake history of previous surveys and/or content.
